(19) United States
(12) Patent Application Publication
(10) Pub. No.: US 2008/0102768 A1
(43) Pub. Date: May 1, 2008

(54) Method for Obtaining a Covariance Matrix of a Transmitting Channel in a Wireless Network

(75) Inventors: Yanxin Na, Plano, TX (US); Hang Jin, Plano, TX (US)

Correspondence Address: L. HOWARD CHEN;KIRKPATRICK & LOCKHART PRESTON GATES ELLIS, LLP, 55 SECOND STREET, # 1700, SAN FRANCISCO, CA, 94105, US

(73) Assignee: Navini Networks, Inc.

(21) Appl. No.: 11/874,702

(22) Filed: Oct. 18, 2007

Related U.S. Application Data
(60) Provisional application No. 60/854,216, filed on Oct. 25, 2006.

(51) Int. Cl. H04B 7/00

(52) U.S. Cl. 455/130

(57) ABSTRACT

The present invention disclosed a method for obtaining a covariance matrix of a transmitting channel in a wireless network. The method comprises calculating a speculative transformation matrix, generating a covariance matrix of a receiving channel, and transforming the covariance matrix of the receiving channel into a covariance matrix of a transmitting channel using the speculative transformation matrix.

### CROSS REFERENCE

The present application claims the benefit of U.S. Provisional Application Ser. 60/854,216, which was filed on Oct. 24, 2006.

### BACKGROUND

In a wireless communications network employing a beamforming method, the quality of downlink signals received by a mobile station (MS) is determined by beamforming weighting vectors of a downlink channel. However, lack of information about channel coefficients of a downlink channel makes it difficult for a base transceiver station (BTS) in a frequency division duplex (FDD) network to obtain optimal beamforming weighting vectors for the downlink channel.

One way to address the issue is to develop a probing-and-feedback mechanism to obtain channel coefficients of a downlink channel. Employing a probing-and-feedback mechanism is not a preferred solution as it requires redesigning wireless communication protocols and incurs a large amount of overhead. In addition, a probing-and-feedback mechanism is only applicable to environments with slow fading channels.

Another way is to compute beamforming weighting vectors for a downlink channel by using a downlink channel covariance matrix that is transformed from an uplink channel covariance matrix. However, most of the algorithms that transform an uplink channel covariance matrix into a downlink channel covariance matrix suffer from high computation complexity.

The issue described above is related to downlink and uplink channels in a communications network employing FDD. Nonetheless, it would be obvious for a person of skills in the art to know the above description is also applicable to other transmitting and receiving channels. As such, what is desired is a method and system for transforming a covariance matrix of a receiving channel into a covariance matrix of a transmitting channel.

### SUMMARY

The present invention disclosed a method for transforming a covariance matrix of a receiving channel into a covariance matrix of a transmitting channel in a wireless network employing frequency division duplex. The method comprises calculating a speculative transformation matrix, generating a covariance matrix of a receiving channel, and transforming the covariance matrix of the receiving channel into a covariance matrix of a transmitting channel using the speculative transformation matrix.

The construction and method of operation of the invention, however, together with additional objects and advantages thereof, will be best understood from the following description of specific embodiments when read in connection with the accompanying drawings.

### BRIEF DESCRIPTION OF THE DRAWING

The drawings accompanying and forming part of this specification are included to depict certain aspects of the invention. The invention may be better understood by reference to one or more of these drawings in combination with the description presented herein. It should be noted that the features illustrated in the drawings are not necessarily drawn to scale.

FIG. 1 is a flow chart diagram illustrating a method in accordance with the present invention

### DESCRIPTION

The following detailed description of the invention refers to the accompanying drawings. The description includes exemplary embodiments, not excluding other embodiments, and changes may be made to the embodiments described without departing from the spirit and scope of the invention. The following detailed description does not limit the invention. Instead, the scope of the invention is defined by the appended claims.

The present invention discloses a method that transforms a covariance matrix of a receiving channel into a covariance matrix of a transmitting channel in a wireless network employing frequency division duplex (FDD). Subsequently, the covariance matrix of the transmitting channel is used to compute beamforming weighting vectors of the transmitting channel.

The algorithm disclosed in the present invention improves the efficiency of computing beamforming weighting vectors in systems such as Macrocell/Microcell FDD OFDMA (Orthogonal Frequency Division Multiple Access). It performs well even when severe multi-path interference exists.

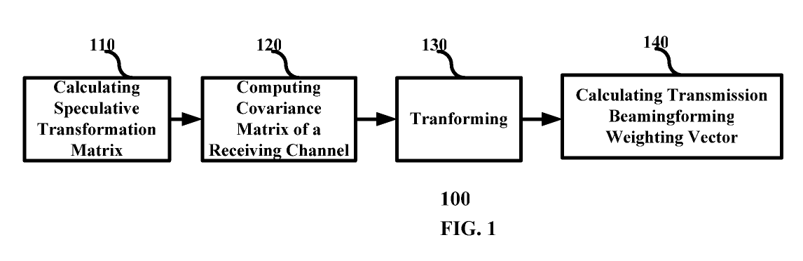

FIG. 1 is a flow chart diagram illustrating a method in accordance with the present invention. The method begins with step 110 of creating a speculative transformation matrix without prior knowledge of the direction of arrival (DOA), θ. A speculative transformation matrix C_{T} is determined by a predetermined number of system parameters such as the number of antennas, the spacing of antennas, the number of sectors, uplink and downlink carrier frequencies, etc. The speculative transformation matrix C_{T} is an M by M matrix (see step 110).

An array-steering vector A(θ,λ), also known as an array response vector, is defined according to the arrangement of an antenna array. It is a function of the direction of arrival (DOA) of receiving signals, denoted as θ, and the wavelength of a wireless channel, denoted as λ. If the antenna array is a uniform linear array (ULA), which is arranged linearly, then A(θ,λ) is equal to

$$A ( θ , λ ) = {[ \begin{matrix}1 & {e}^{j \frac{2 π D}{λ} sin ( θ )} & … & {e}^{j \frac{2 π D}{λ} ( M - 1 ) sin ( θ )}\end{matrix} ]}^{T} ,$$

where D is the distance between two adjacent antennas.

By contrast, if the antenna array is a uniform circular array (UCA), which is arranged circularly, then A(θ,λ) is equal to

$$A ( θ , λ ) = {[ \begin{matrix}{e}^{- j \frac{2 π r}{λ} cos ( θ )} & {e}^{- j \frac{2 π r}{λ} cos ( θ - \frac{2 π}{M} )} & … & {e}^{- j \frac{2 π r}{λ} cos ( θ - \frac{( M - 1 ) 2 π}{M} ) )}\end{matrix} ]}^{T} ,$$

where r is the radius of a circular array.

A response matrix is represented by the following equation: Q(θ)=A(θ,λ)A^{H}(θ,λ) (1), where (.)^{H} is a Hermitian operator. In a frequency division duplex wireless network, the response matrix of a transmitting channel is denoted as Qₜₓ(θ)=A(θ,λₜₓ)A^{H}(θ,λₜₓ) whereas the response matrix of a receiving channel is denoted as Qᵣₓ(θ)=A(θ,λᵣₓ)A^{H}(θ,λᵣₓ).

Assuming that there are N_{sector} sectors in a cell, each sector is a pie shape. Each sector covers a region with a vertex angle of 2π/N_{sector}. In other words, it spans from angle −π/N_{sector} to angle π/N_{sector}. Let φ equal π/N_{sector}.

A sector is further divided into Nₐ partitions of the same size. Each partition has a vertex angle of Δ and Δ=2φ/(Nₐ−1). The transmitting and receiving response matrices of each partition are calculated according to equation 1. The DOA of the i-th partition, denoted as θ, equals (i−1)Δ−φ. The cumulative transmitting and receiving response matrices are defined by the following equations respectively.

$${\tilde{Q}}_{tx} = [ \begin{matrix}{Q}_{tx} ( - φ ) \\ {Q}_{tx} ( Δ - φ ) \\ ⋮ \\ {Q}_{tx} ( ( {N}_{a} - 1 ) Δ - φ )\end{matrix} ]$$

$$and$$

$${\tilde{Q}}_{rx} = [ \begin{matrix}{Q}_{rx} ( - φ ) \\ {Q}_{rx} ( Δ - φ ) \\ ⋮ \\ {Q}_{rx} ( ( {N}_{a} - 1 ) Δ - φ )\end{matrix} ]$$

### Thus, a speculative transformation matrix C_{T} is given by C_{T}=(\tilde{Q}ᵣₓ^{H}\tilde{Q}ᵣₓ)⁻¹\tilde{Q}ᵣₓ^{H}\tilde{Q}ₜₓ.

In step 120, channel coefficients of a receiving channel in frequency domain for a desired wireless station is estimated to be Hᵣₓ=[H_{rx,1} H_{rx,2} . . . H_{rx,M}]^{T}, where operator [*]^{T} represents vector transpose and M is a total number of antennas in a transmitting wireless station. Let Rᵣₓ be a covariance matrix of a receiving channel. The instantaneous covariance matrix of a receiving channel is computed according to the following equation: Rᵣₓ=Hᵣₓ(Hᵣₓ)^{H}. The average covariance matrix of the receiving channel is computed according to the following equation:

$${R}_{rx} = \frac{1}{{N}_{e}} {\sum }_{i = 1}^{{N}_{e}} {{H}_{i , rx} ( {H}_{i , rx} )}^{H} ,$$

where Nₑ is the number of samples and Nₑ is between [1, ∝).

In step 130, the covariance matrix Rₜₓ of a transmitting channel is transformed from the receiving covariance matrix Rᵣₓ according to the following equation: Rₜₓ=RᵣₓC_{T}.

In step 140, the covariance matrix of the transmitting channel is used to compute a transmitting beamforming weighting vector wₜₓ by finding the principal eigenvector of a channel covariance matrix problem. The principal eigenvector corresponds to a maximum eigenvalue.

Let X(t) be transmitting signals in frequency domain for a BTS. Transmitting signals in time domain for an antenna array are computed according to the following equation: s(t)=ifft(wₜₓ^{H}X(t)) where ifft is the Inverse discrete Fast Fourier Transform (IFFT).

The method disclosed in the present invention creates a fixed speculative transformation matrix for a transmission/reception system of an antenna array, generates an average covariance matrix of a receiving channel, and creates a covariance matrix of a transmitting channel by multiplying the average channel covariance matrix of the receiving channel with the fixed speculative transformation matrix.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A method for obtaining a covariance matrix of a transmitting channel in a wireless network, the method comprising:
calculating a speculative transformation matrix from a receiving channel;
generating a covariance matrix of the receiving channel; and
transforming the covariance matrix of the receiving channel into a covariance matrix of a transmitting channel using the speculative transformation matrix.

2. The method of claim 1, wherein the calculating the speculative transformation matrix comprises:
generating a plurality of arrays of steering vectors of the transmitting channel;
computing a plurality of transmitting response matrices using the plurality of steering vectors of the transmitting channel;
generating a plurality of arrays of steering vectors of the receiving channel; and
computing a plurality of receiving response matrices using the plurality of steering vector of the receiving channel.

3. The method of claim 2, wherein the calculating the speculative transformation matrix further comprises:
computing a cumulative transmitting response matrix using the plurality of transmitting response matrices of the transmitting channel; and
computing a cumulative receiving response matrix using the plurality of transmitting response matrices of the transmitting channel.

4. The method of claim 3, wherein the computing the cumulative transmitting response matrix (\tilde{Q}ₜₓ) is based on the following equation:
$${\tilde{Q}}_{tx} = [ \begin{matrix}{Q}_{tx} ( - φ ) \\ {Q}_{tx} ( Δ - φ ) \\ ⋮ \\ {Q}_{tx} ( ( {N}_{a} - 1 ) Δ - φ )\end{matrix} ] ,$$
where i=[0, . . . , Nₐ−1]; Nₐ is a total number of partitions in a cell; and Qₜₓ((i−1)Δ−φ) is a transmitting response matrix with a direction of arrival equal to (i−1)Δ−φ.

5. The method of claim 3, wherein the computing the cumulative receiving response matrix (\tilde{Q}ᵣₓ) is based on the following equation:
$${\tilde{Q}}_{rx} = [ \begin{matrix}{Q}_{rx} ( - φ ) \\ {Q}_{rx} ( Δ - φ ) \\ ⋮ \\ {Q}_{rx} ( ( {N}_{a} - 1 ) Δ - φ )\end{matrix} ] ,$$
where i=[0, . . . , Nₐ−1]; Nₐ is a total number of partitions in a cell; and Qᵣₓ((i−1)Δ−φ) is a receiving response matrix with a direction of arrival equal to (i−1)Δ−φ.

6. The method of claim 3, wherein the calculating the speculative transformation matrix comprises a step of computing C_{T}=(\tilde{Q}ᵣₓ^{H}\tilde{Q}ᵣₓ)⁻¹\tilde{Q}ᵣₓ^{H}\tilde{Q}ₜₓ, where C_{T} is a speculative transformation matrix; \tilde{Q}ₜₓ is a cumulative transmitting response matrix; \tilde{Q}ᵣₓ is a cumulative receiving response matrix; and (.)^{H} is a Hermitian operator.

7. The method of claim 1, wherein the transforming the covariance matrix of the receiving channel into a covariance matrix of the transmitting channel is based on the following equation: Rₜₓ=RᵣₓC_{T}, where, C_{T} is a speculative transformation matrix; Rₜₓ is a covariance matrix of a transmitting channel; and Rᵣₓ is a covariance matrix of a receiving channel.

8. A method for obtaining a covariance matrix of a transmitting channel in a wireless network, the method comprising:
calculating a speculative transformation matrix by generating a plurality of arrays of steering vectors of the transmitting channel, computing a plurality of transmitting response matrices, generating a plurality of arrays of steering vectors of a receiving channel, and computing a plurality of receiving response matrices;
generating a covariance matrix of a receiving channel; and
transforming the covariance matrix of the receiving channel into a covariance matrix of a transmitting channel using the following equation: Rₜₓ=RᵣₓC_{T}, where, C_{T} is a speculative transformation matrix; Rₜₓ is a covariance matrix of a transmitting channel; and Rᵣₓ is a covariance matrix of a receiving channel.

9. The method of claim 8, wherein the calculating the speculative transformation matrix comprises:
computing a cumulative transmitting response matrix using the plurality of transmitting response matrices of the transmitting channel; and
computing a cumulative receiving response matrix using the plurality of transmitting response matrices of the transmitting channel.

10. The method of claim 9, wherein the computing the cumulative transmitting response matrix (\tilde{Q}ₜₓ) is based on the following equation:
$${\tilde{Q}}_{tx} = [ \begin{matrix}{Q}_{tx} ( - φ ) \\ {Q}_{tx} ( Δ - φ ) \\ ⋮ \\ {Q}_{tx} ( ( {N}_{a} - 1 ) Δ - φ )\end{matrix} ] ,$$
where i=[0, . . . , Nₐ−1]; Nₐ is a total number of partitions in a cell; and Qₜₓ((i−1)Δ−φ) is a transmitting response matrix with a direction of arrival equal to (i−1)Δ−φ.

11. The method of claim 9, wherein the computing the cumulative receiving response matrix (\tilde{Q}ᵣₓ) is based on the following equation:
$${\tilde{Q}}_{rx} = [ \begin{matrix}{Q}_{rx} ( - φ ) \\ {Q}_{rx} ( Δ - φ ) \\ ⋮ \\ {Q}_{rx} ( ( {N}_{a} - 1 ) Δ - φ )\end{matrix} ] ,$$
where i=[0, . . . , Nₐ−1]; Nₐ is a total number of partitions in a cell; and Qᵣₓ((i−1)Δ−φ) is a receiving response matrix with a direction of arrival equal to (i−1)Δ−φ.

12. The method of claim 9, wherein the calculating the speculative transformation matrix comprises a step of computing C_{T}=(\tilde{Q}ᵣₓ^{H}\tilde{Q}ᵣₓ)⁻¹\tilde{Q}ᵣₓ^{H}\tilde{Q}ₜₓ, where C_{T} is a speculative transformation matrix; \tilde{Q}ₜₓ is a cumulative transmitting response matrix; \tilde{Q}ᵣₓ is a cumulative receiving response matrix; and (.)^{H} is a Hermitian operator.

13. A method for transforming a covariance matrix of a receiving channel into a covariance matrix of a transmitting channel in a wireless network employing frequency division duplex, the method comprising:
calculating a speculative transformation matrix from a receiving channel;
generating a covariance matrix of the receiving channel; and
transforming the covariance matrix of the receiving channel into a covariance matrix of a transmitting channel using the speculative transformation matrix.

14. The method of claim 13, wherein the calculating the speculative transformation matrix comprises:
generating a plurality of arrays of steering vectors of the transmitting channel;
computing a plurality of transmitting response matrices using the plurality of steering vectors of the transmitting channel;
generating a plurality of arrays of steering vectors of the receiving channel; and
computing a plurality of receiving response matrices using the plurality of steering vector of the receiving channel.

15. The method of claim 14, wherein the calculating the speculative transformation matrix further comprises:
computing a cumulative transmitting response matrix using the plurality of transmitting response matrices of the transmitting channel; and
computing a cumulative receiving response matrix using the plurality of transmitting response matrices of the transmitting channel.

16. The method of claim 15, wherein the computing the cumulative transmitting response matrix (\tilde{Q}ₜₓ) is based on the following equation:
$${\tilde{Q}}_{tx} = [ \begin{matrix}{Q}_{tx} ( - φ ) \\ {Q}_{tx} ( Δ - φ ) \\ ⋮ \\ {Q}_{tx} ( ( {N}_{a} - 1 ) Δ - φ )\end{matrix} ] ,$$
where i=[0, . . . , Nₐ−1]; Nₐ is a total number of partitions in a cell; and Qₜₓ((i−1)Δ−φ) is a transmitting response matrix with a direction of arrival equal to (i−1)Δ−φ.

17. The method of claim 15, wherein the computing the cumulative receiving response matrix (\tilde{Q}ᵣₓ) is based on the following equation:
$${\tilde{Q}}_{rx} = [ \begin{matrix}{Q}_{rx} ( - φ ) \\ {Q}_{rx} ( Δ - φ ) \\ ⋮ \\ {Q}_{rx} ( ( {N}_{a} - 1 ) Δ - φ )\end{matrix} ] ,$$
where i=[0, . . . , Nₐ−1]; Nₐ is a total number of partitions in a cell; and Qᵣₓ((i−1)Δ−φ) is a receiving response matrix with a direction of arrival equal to (i−1)Δ−φ.

18. The method of claim 15, wherein the calculating the speculative transformation matrix comprises a step of computing C_{T}=(\tilde{Q}ᵣₓ^{H}\tilde{Q}ᵣₓ)⁻¹\tilde{Q}ᵣₓ^{H}\tilde{Q}ₜₓ, where C_{T} is a speculative transformation matrix; \tilde{Q}ₜₓ is a cumulative transmitting response matrix; \tilde{Q}ᵣₓ is a cumulative receiving response matrix; and (.)^{H} is a Hermitian operator.

19. The method of claim 13, wherein the transforming the covariance matrix of the receiving channel into a covariance matrix of the transmitting channel is based on the following equation: Rₜₓ=RᵣₓC_{T}, where, C_{T} is a speculative transformation matrix; Rₜₓ is a covariance matrix of a transmitting channel; and Rᵣₓ is a covariance matrix of a receiving channel.
